(19) United States
(12) Patent Application Publication
(10) Pub. No.: US 2005/0205607 A1
(43) Pub. Date: Sep. 22, 2005

(54) Child-resistant flip-top closure

(76) Inventors: Valentin Hierzer, Arlington Heights, IL (US); Juergen Pellenz, Zell-Moesl (DE)

Correspondence Address: KNOBLE YOSHIDA & DUNLEAVY, LLC;Eight Penn Center, Suite 1350, 1628 John F. Kennedy Blvd., Philadelphia, PA, 19103, US

(21) Appl. No.: 10/805,710

(22) Filed: Mar. 22, 2004

(51) Int. Cl. B67B 5/00; B67D 5/32

(52) U.S. Cl. 222/153.1; 222/153.02; 222/556; 222/546

(57) ABSTRACT

A child resistant container assembly includes a container and a child resistant flip-top type closure that is secured onto the container. The flip-top type closure includes a main closure body having internal threading that is engaged with external threading that is provided on a neck portion of the container. A dispensing orifice is provided in the main closure body for dispensing a substance, such as detergent, from the container. Retention structure is provided for deterring removal of the closure main body from the container after the closure main body has been screwed onto the container. A lid member is hingedly mounted to the closure main body for movement between a first, closed position that covers the orifice and a second, open position wherein the dispensing orifice is uncovered and the substance within the container may be freely dispensed. A child safety interlock is advantageously provided for securing the lid member in the closed position until an unlocking action other than simply lifting the lid member is performed by a consumer.

### BACKGROUND OF THE INVENTION

1. Field of the Invention

This application relates to dispensing closures, and particularly to child resistant dispensing closures for dispensing materials, such as liquid detergents, that are unsuitable for human consumption.

2. Description of the Related Technology

Dispensing closures are in wide use for dispensing materials, particularly liquids, throughout the world. A dispensing closure is simply an article that is mountable onto a container that is designed to permit closure of an orifice of the container and, when the closure is opened, to permit material to be dispensed from the container through the orifice and the dispensing closure. Dispensing closures are quite common in the packaging of certain beverages, such as sports drinks, but are also used to dispense materials, such as oils and liquid detergents, that are unsuitable for human consumption.

One type of dispensing closure that is increasingly popular is the flip-top variety, which is characterized by a main body portion that is securable to a container and a lid portion that is hingedly mounted to the main body portion. The main body portion typically includes a dispensing orifice that is sealed by closure of the lid and uncovered when the lid is opened. When a consumer desires to dispense liquid from this type of dispensing closure, he or she will flip the lid open and squeeze or invert the container.

Of course, it is desirable that any closure that is used for dispensing material that is unsuitable for human consumption be configured so that it is as resistant to opening by infants and young children as possible. The packaging industry today has been unable to provide a child resistant flip-top type closure. A need exists, however, for an effective flip-top type dispensing closure that is effective in preventing opening by infants and small children, but that presents little difficulty to an adult.

### SUMMARY OF THE INVENTION

Accordingly, it is an object of the invention to provide an effective flip-top type dispensing closure that is effective in preventing opening by infants and small children, but that presents little difficulty to an adult.

In order to achieve the above and other objects of the invention, a child resistant, flip-top plastic closure for a container according to a first aspect of the invention includes a closure main body that is adapted to be secured to a container, the closure main body having an orifice defined therein for dispensing a substance from the container; a lid member that is hingedly mounted to the closure main body for movement between a first closed position wherein the lid member covers the orifice and an open position wherein the orifice is uncovered by the lid member; and child safety interlock structure for securing the lid member in the first, closed position relative to the closure main body until an unlocking action other than lifting the lid member is performed by a consumer.

According to a second aspect of the invention, a child resistant container assembly includes a container having at least one sidewall that defines an interior space, the container comprising a neck portion with external threading provided thereon; a closure main body having internal threading that is interengaged with the external threading of the container neck portion, the closure main body having an orifice defined therein for dispensing a substance from the container; retention structure for deterring removal of the closure main body from the container after the closure main body has been screwed onto the container; a lid member that is hingedly mounted to the closure main body for movement between a first closed position wherein the lid member covers the orifice and an open position wherein the orifice is uncovered by the lid member; and child safety interlock structure for securing the lid member in the first, closed position relative to the closure main body until an unlocking action other than lifting the lid member is performed by a consumer.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is an isometric view of a child resistant flip-top closure constructed according to the preferred embodiment of the invention, shown in a closed position;

FIG. 2 is an isometric view of the closure shown in FIG. 1, depicted in an open position;

FIG. 3 is a cross-sectional view taken along lines 3-3 of FIG. 1;

FIG. 4 is a cross-sectional view similar to that of FIG. 3, shown in a different operational position;

FIG. 5 is an isometric view of a container assembly according to the preferred embodiment of the invention;

FIG. 6 is a cross-sectional view taken along lines 6-6 in FIG. 5;

FIG. 7 is a bottom isometric view of the closure that is shown in FIG. 1;

FIG. 8 is an isometric view of an upper neck portion of the container that is depicted in FIG. 5; and

FIG. 9 is a different isometric view showing the upper neck portion of the container shown in FIG. 8.

### DETAILED DESCRIPTION OF THE PREFERRED EMBODIMENT(S)

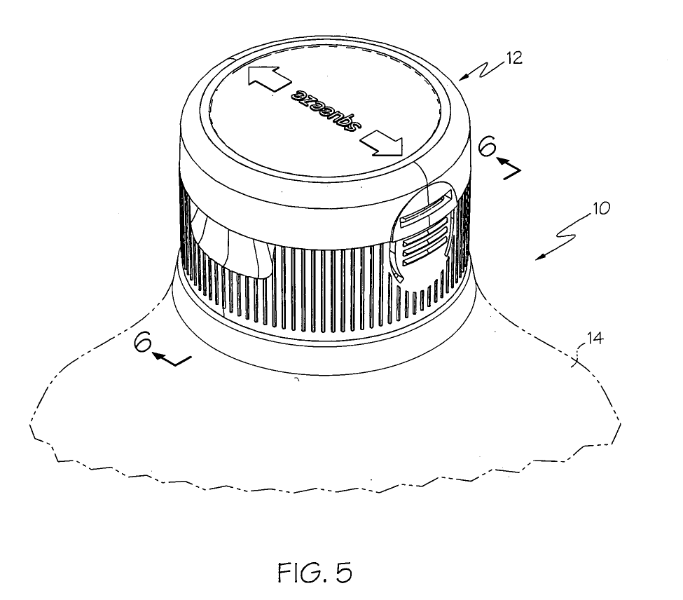

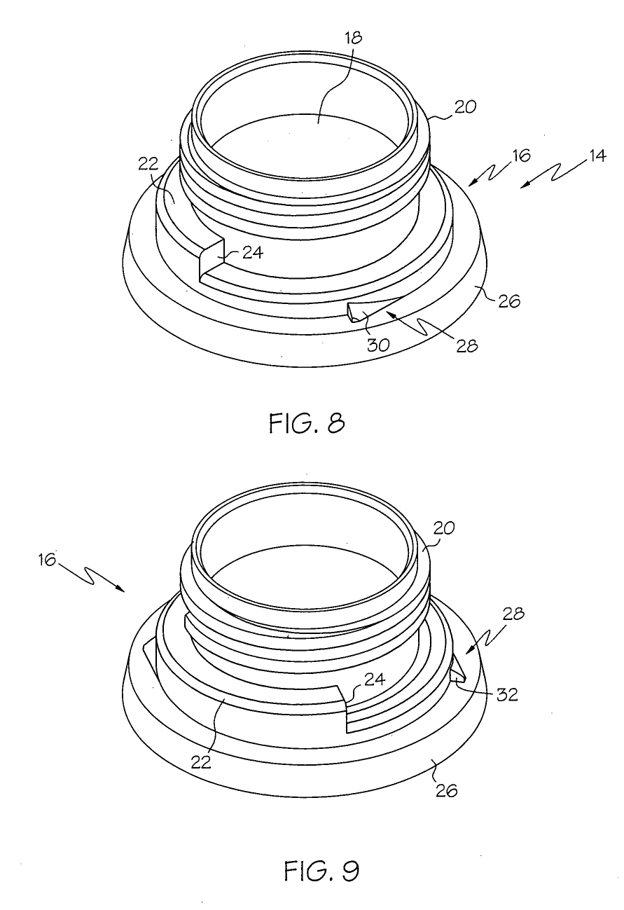

Referring now to the drawings, wherein like reference numerals designate corresponding structure throughout the views, and referring first to FIG. 5, a child resistant container assembly 10 that is constructed according to the preferred embodiment of the invention includes a child resistant flip-top type closure 12 and a container 14. Referring briefly to FIGS. 8 and 9, it will be seen that container 14 includes a neck portion 16 defined around an orifice 18 that is in communication with an internal space of the container 14. Neck portion 16 includes a main cylindrical portion having external threading 20 defined thereon. Neck portion 16 further includes a first annular shoulder 22 that is proximate to and slightly beneath the external threading 20 and that has a substantially vertical dead stop surface 24 defined therein for purposes that will be described in greater detail below. A second annular shoulder 26 is positioned proximate to the external threading 20 and the first annular shoulder 22 and slightly beneath the first annular shoulder 22. Second annular shoulder 26 includes a pair of ratchet members 28 defined therein, each of which has inclined ramp surface 30 and an intersecting vertical stop surface 32.

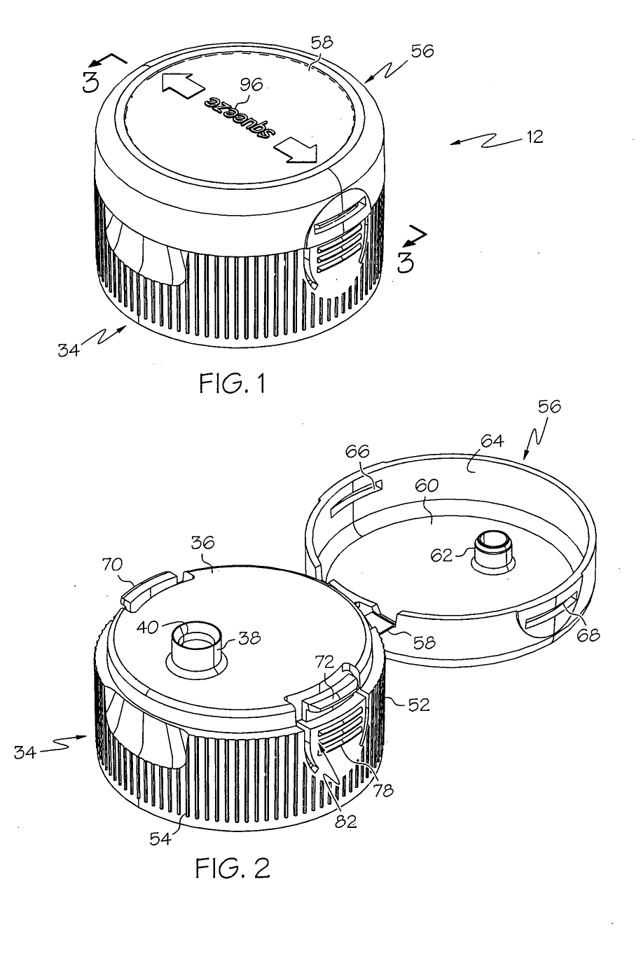

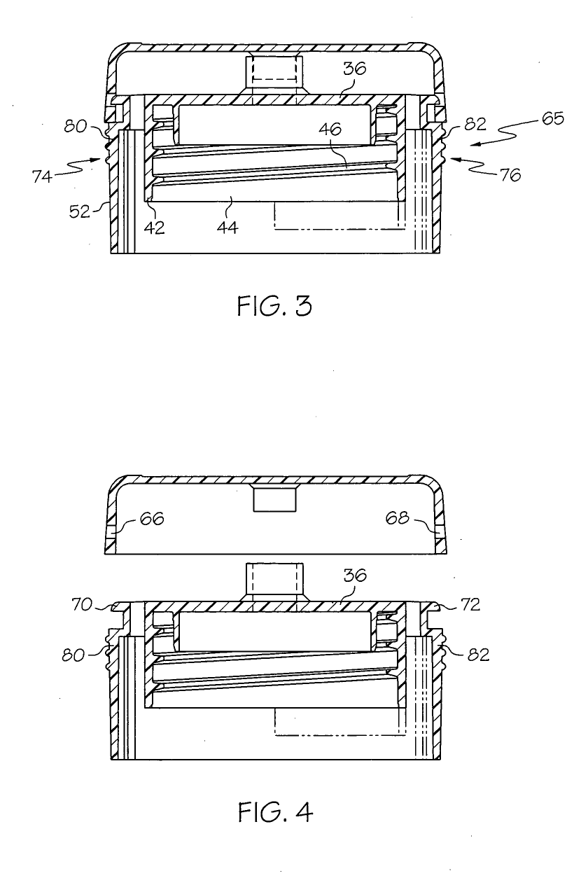

Referring now to FIGS. 1-4, it will be seen that closure 12 includes a main closure body 34 having a top wall 36, the top surface thereof defining a relatively flat dispensing platform in which a dispensing nozzle 38 having a dispensing orifice 40 is defined therein. Dispensing orifice 40 is in communication with the orifice 18 of the container 14 when the closure 12 is secured on to the container 14. A substance that is stored within the container 14, such as liquid dishwashing detergent, may thus be dispensed from the dispensing orifice 40 when the closure 12 is opened and the container 14 is inverted or squeezed. As may best be seen in FIG. 3, main closure body 34 includes a downwardly depending internal substantially cylindrical boss member 42 that is unitary with the top wall 36 and that has an inner surface 44 upon which a plurality of internal threads 46 are defined. These internal threads 46 are sized and shaped to mate with the external threading 20 of the neck portion 16 of the container 14.

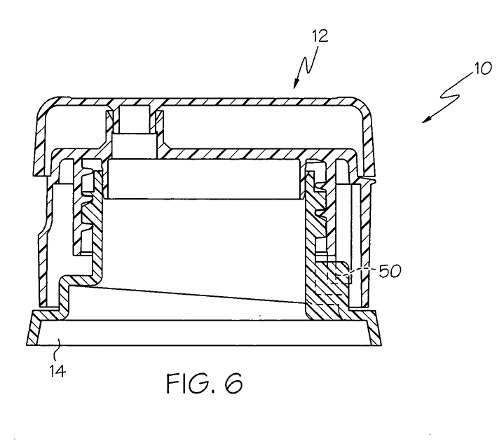

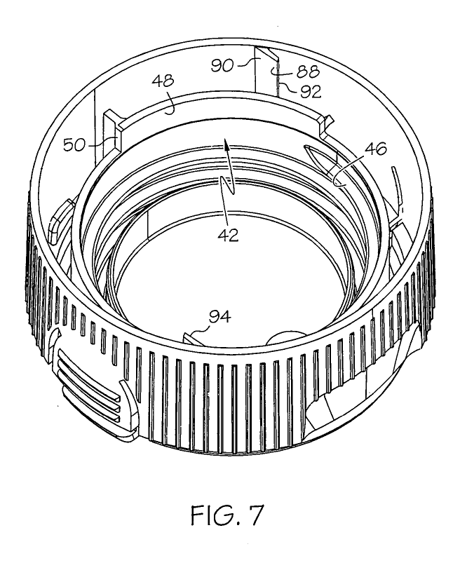

Looking briefly to FIG. 7, which is a bottom isometric view of the main closure body 34, it will be seen that the boss member 42 includes a downwardly extending segmental annular projection 48 that defines a substantially vertical stop surface 50. As can best be seen in FIG. 6, vertical stop surface 50 engages with the vertical dead stop surface 24 on the neck portion 16 of the container 14 when the closure 12 is screwed on to the container 14 so that overtightening of the closure 12 with respect to the container 14 is prevented.

Returning to FIGS. 1-4, the main body portion 34 of the closure 12 further includes a downwardly depending flexible outer sidewall 52 that is preferably provided with gripping structure such as a plurality of gripping ribs 54 on the outer circumferential surface thereof. Closure 12 further includes a lid member 56 that is hingedly mounted in conventional flip-top fashion to the main body portion 34 by means of a hinge 58. In the preferred embodiment, the entire closure 12 including the main body portion 34, the lid member 56 and the hinge 58 is unitary molded as a single piece from a suitable plastic material such as high-density polyethylene or polypropylene. As may best be seen in FIG. 2, lid member 56 includes an upper wall 58 from which a plug member 62 extends downwardly from a lower surface 60 thereof. Plug member 62 fits within the dispensing orifice 40 of the dispensing nozzle 38, preferably in a snap in type action, when the closure 12 is in the closed position shown in FIG. 3. Lid member 56 further has a downwardly depending outer substantially cylindrical circumferentially extending sidewall 64 in which an opposing pair of detents 66, 68 are defined. In the preferred embodiment, detents 66, 68 are constructed as through holes that extend through the entire wall thickness of the sidewall 64, but could alternatively be constructed as recesses that are defined in the interior surface of the sidewall 64 but do not extend through the outer circumferential surface of the sidewall 64. Detents 66, 68 are diametrically opposed from each other and form part of a child safety interlock system 65 that advantageously secures the lid member 56 in the closed position until an unlocking action other than simply lifting the lid member 56 is performed by the consumer. Interlock system 65 further includes a pair of first and second latching pawls 70, 72 that are sized and shaped to be received within the first and second detents 66, 68 when the interlock system 65 is engaged. The first and second latching pawls 70, 72 are respectively mounted on distal ends of first and second lever members 80, 82 that are unitary with and cantilevered from the outer sidewall 52 of the closure main body 34. First and second actuation surfaces 74, 76 are defined on the respective outer surfaces of the first and second lever members 80, 82 and have a gripping surface 78 that in the preferred embodiment includes a plurality of horizontally extending ribs. By exerting a predetermined force, specifically a radial squeezing force, in the area of the first and second actuation surfaces 74, 76 when the closure 12 is in the locked position shown in FIG. 1 the cantilevered lever members 80, 82 will be caused to deflect inwardly, particularly at their distal ends, which will cause the first and second latching pawls 70, 72 to unseat themselves from the respective detents 66, 68 in the lid member 56 thereby releasing the interlock. Preferably, the predetermined radial squeezing force that is required to release the interlock is a force that would be beyond the expected strength of a small child. Preferably, this radial squeezing force is within a range of about 0.5 to about 5.0 pounds of force, and more preferably within a range of about 1.0 to about 3.0 pounds of force.

As is that shown in FIG. 1, indicium 96 is preferably provided on the upper surface of the top wall 58 to instruct the consumer how to operate the interlock system 65.

According to another advantageous feature of the invention, retention structure is preferably provided for deterring removal of the closure 12 from the container 14 after the closure 12 has been secured to the container 14. Referring to FIG. 7, it will be seen that a pair of longitudinally extending ratchet ribs 88, 94 extend inwardly at an angle with respect to the radial direction from the inner surface of the outer sidewall 52 of the closure main body 34. Each of the ratchet ribs 80, 94 includes a ramped surface 90 leading to an internal edge 92. As the closure 12 is screwed on to the neck portion 16 of the container 14 the ramped surfaces 90 of the first and second ratchet ribs 88, 94 will engage and glide over the inclined ramp surfaces 30 of the ratchet members 28 that are defined on the second annular shoulder 26 of the container 14. However, any attempt to unscrew the closure 12 from the container 14 will be arrested by contact between the edge 92 of one of the ratchet ribs 88, 94 and the vertical stop surface 32 of one of the ratchet members 28. This retention structure is preferably constructed and arranged to prevent removal of the closure 12 from the container 14 by a person having strength that would be expected of a small child. In order to satisfy this standard, a predetermined minimum unscrewing torque is required to defeat the retention structure that is preferably at least 20 inch-pounds of torque, and is even more preferably at least 30 inch-pounds of torque.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A child resistant, flip-top plastic closure for a container, comprising:
a closure main body that is adapted to be secured to a container, said closure main body having an orifice defined therein for dispensing a substance from the container;
a lid member that is hingedly mounted to said closure main body for movement between a first closed position wherein said lid member covers said orifice and an open position wherein said orifice is uncovered by said lid member; and
child safety interlock means for securing said lid member in said first, closed position relative to said closure main body until an unlocking action other than lifting said lid member is performed by a consumer.

2. A child resistant flip-top plastic closure for a container according to claim 1, wherein said closure main body further comprises retention means for deterring removal of said closure from the container after the closure has been secured to the container.

3. A child resistant flip-top plastic closure for a container according to claim 2, wherein said retention means is constructed and arranged to prevent removal of the closure from the container by a person having strength that is expected of a small child.

4. A child resistant flip-top plastic closure for a container according to claim 2, wherein said closure main body comprises a threaded internal surface that is sized and shaped to be screwed on to an externally threaded finish portion of a container, and wherein said retention means comprises ratchet means for deterring unscrewing of the closure main body from the container.

5. A child resistant flip-top plastic closure for a container according to claim 4, wherein said ratchet means is constructed and arranged to prevent unscrewing of the closure main body from the container when a minimum unscrewing torque is applied to the closure, and wherein said minimum unscrewing torque is at least 20 inch-pounds of torque.

6. A child resistant flip-top plastic closure for a container according to claim 1, wherein said lid member comprises a plug for sealing said orifice when said lid member is in the first, closed position.

7. A child resistant flip-top plastic closure for a container according to claim 1, wherein said child safety interlock means comprises latch means for releasably engaging structure on one of said lid member and said closure main body and selective actuation means that is selectively actuatable by the consumer for releasably disengaging said latch means.

8. A child resistant flip-top plastic closure for a container according to claim 7, wherein said latch means is for releasably engaging structure on said lid member.

9. A child resistant flip-top plastic closure for a container according to claim 8, wherein said actuation means is mounted on said closure main body.

10. A child resistant flip-top plastic closure for a container according to claim 9, wherein said actuation means is integral with said closure main body.

11. A child resistant flip-top plastic closure for a container according to claim 10, wherein said actuation means comprises at least one lever member that is cantilevered to said closure main body.

12. A child resistant flip-top plastic closure for a container according to claim 11, wherein said latch means is located at a distal end of said lever member.

13. A child resistant flip-top plastic closure for a container according to claim 11, wherein said lever member is constructed and arranged to be depressible by a consumer by exerting a radially inward force against an outer surface of said lever member.

14. A child resistant flip-top plastic closure for a container according to claim 13, further comprising gripping structure provided on said outer surface of said lever member for aiding a consumer in gripping said outer surface.

15. A child resistant flip-top plastic closure for a container according to claim 8, wherein said lid member has a detent defined therein, and wherein said latch means is constructed and arranged to releasably engage said detent.

16. A child resistant flip-top plastic closure for a container according to claim 15, wherein said lid member comprises a top wall and a downwardly depending generally cylindrical sidewall, and wherein said detent is defined in said sidewall.

17. A child resistant flip-top plastic closure for a container according to claim 7, wherein said selective actuation means is constructed and arranged to releasably disengage said latch means when a consumer exerts a predetermined force on at least one actuation surface.

18. A child resistant flip-top plastic closure for a container according to claim 17, wherein said predetermined force comprises at least about 0.5 pounds of force.

19. A child resistant flip-top plastic closure for a container according to claim 17, wherein said actuation force is exerted in a radially inward direction.

20. A child resistant flip-top plastic closure for a container according to claim 17, wherein said selective actuation means comprises two of said actuation surfaces, and wherein said actuation surfaces are diametrically opposed.

21. A child resistant flip-top plastic closure for a container according to claim 7, further comprising indicia on said lid member instructing a consumer how to actuate said actuation means.

22. A child resistant container assembly, comprising:
a container having at least one sidewall that defines an interior space, said container comprising a neck portion with external threading provided thereon;
a closure main body having internal threading that is interengaged with said external threading of said container neck portion, said closure main body having an orifice defined therein for dispensing a substance from the container;
retention means for deterring removal of said closure main body from said container after the closure main body has been screwed onto said container;
a lid member that is hingedly mounted to said closure main body for movement between a first closed position wherein said lid member covers said orifice and an open position wherein said orifice is uncovered by said lid member; and
child safety interlock means for securing said lid member in said first, closed position relative to said closure main body until an unlocking action other than lifting said lid member is performed by a consumer.

23. A child resistant container assembly according to claim 22, wherein said retention means is constructed and arranged to prevent removal of the closure from the container by a person having strength that is expected of a small child.

24. A child resistant container assembly according to claim 22, wherein said closure main body comprises a threaded internal surface that is sized and shaped to be screwed on to an externally threaded finish portion of a container, and wherein said retention means comprises ratchet means for deterring unscrewing of the closure main body from the container.

25. A child resistant container assembly according to claim 24, wherein said ratchet means is constructed and arranged to prevent unscrewing of the closure main body from said container when a minimum unscrewing torque is applied to the closure, and wherein said minimum unscrewing torque is at least 20 inch-pounds of torque.

26. A child resistant container assembly according to claim 22, wherein said lid member comprises a plug for sealing said orifice when said lid member is in the first, closed position.

27. A child resistant container assembly according to claim 22, wherein said child safety interlock means comprises latch means for releasably engaging structure on one of said lid member and said closure main body and selective actuation means that is selectively actuatable by the consumer for releasably disengaging said latch means.

28. A child resistant container assembly according to claim 27, wherein said latch means is for releasably engaging structure on said lid member.

29. A child resistant container assembly according to claim 28, wherein said actuation means is mounted on said closure main body.

30. A child resistant container assembly according to claim 29, wherein said actuation means is integral with said closure main body.

31. A child resistant container assembly according to claim 30, wherein said actuation means comprises at least one lever member that is cantilevered to said closure main body.

32. A child resistant container assembly according to claim 31, wherein said latch means is located at a distal end of said lever member.

33. A child resistant container assembly according to claim 31, wherein said lever member is constructed and arranged to be depressible by a consumer by exerting a radially inward force against an outer surface of said lever member.

34. A child resistant container assembly according to claim 33, further comprising gripping structure provided on said outer surface of said lever member for aiding a consumer in gripping said outer surface.

35. A child resistant container assembly according to claim 27, wherein said lid member has a detent defined therein, and wherein said latch means is constructed and arranged to releasably engage said detent.

36. A child resistant container assembly according to claim 35, wherein said lid member comprises a top wall and a downwardly depending generally cylindrical sidewall, and wherein said detent is defined in said sidewall.

37. A child resistant container assembly according to claim 27, wherein said selective actuation means is constructed and arranged to releasably disengage said latch means when a consumer exerts a predetermined force on at least one actuation surface.

38. A child resistant container assembly according to claim 37, wherein said predetermined force comprises at least about 0.5 pounds of force.

39. A child resistant container assembly according to claim 37, wherein said selective actuation means comprises two of said actuation surfaces, and wherein said actuation surfaces are diametrically opposed.

40. A child resistant container assembly according to claim 27, further comprising indicia on said lid member instructing a consumer how to actuate said actuation means.

41. A child resistant container assembly according to claim 37, wherein said selective actuation means is constructed and arranged to releasably disengage said latch means when a consumer exerts a predetermined radially inward force on at least one actuation surface.
